(19) United States
(12) Patent Application Publication
(10) Pub. No.: US 2019/0275940 A1
(43) Pub. Date: Sep. 12, 2019

(54) VEHICLE PERIPHERY DISPLAY SYSTEM, DISPLAY CONTROL DEVICE, AND RECORDING MEDIUM

(71) Applicant: PANASONIC INTELLECTUAL PROPERTY MANAGEMENT CO., LTD., Osaka (JP)

(72) Inventor: Masazumi YAMAZAKI, Kanagawa (JP)

(73) Assignee: PANASONIC INTELLECTUAL PROPERTY MANAGEMENT CO., LT D., Osaka (JP)

(21) Appl. No.: 16/289,006

(22) Filed: Feb. 28, 2019

(30) Foreign Application Priority Data
Mar. 6, 2018 (JP) 2018-040239

(51) Int. Cl. B60R 1/00; H04N 7/18; H04N 5/272; G09G 5/02

(52) U.S. Cl. CPC B60R 1/00; H04N 7/183; H04N 5/272; B60R 2001/1253; G09G 2380/10; G09G 2340/12; G09G 2320/0666; G09G 5/02

(57) ABSTRACT

An image capturing device captures an image of the periphery of a vehicle and outputs the captured image to a display control device. The display control device generates a display image in which a predetermined guide line overlaps the image captured by the image capturing device. A display device displays the display image generated by the display control device. The display control device generates a display image in which a plurality of points having a color different from that of the guide line are arranged at intervals along the guide line.

### BACKGROUND

### 1. Field

The present disclosure relates to a data processing technology, and more particularly, to a technology of displaying an image of the periphery of a vehicle.

### 2. Description of the Related Art

In the conventional practice, a driver needs to visually check a situation of the periphery of a vehicle in order to safely drive the vehicle. Heretofore, a side mirror or the like has been used to check an area which cannot be directly visually checked. However, in some cases, a camera monitoring system which captures an image of a situation of the periphery of a vehicle by using a vehicle-mounted camera and displays the captured image on a monitor or the like is mounted in the vehicle.

Patent Literature 1: Jpn. Pat. Appln. KOKAI Publication No. 2010-47253

When a shadow line is added as an emphasizing means for a guide line on an image of a camera monitoring system, there is a possibility that visibility of a background image deteriorates.

### SUMMARY

The present disclosure has been made in view of the above circumstances, an object of the present disclosure is to provide a technology of generating a suitable display image from an image obtained by capturing an image of the periphery of a vehicle.

According to one aspect of the present disclosure, a vehicle periphery display system includes: an image capturing device structured to capture an image of a periphery of a vehicle; a display control device structured to generate a display image in which a predetermined guide line overlaps the image captured by the image capturing device; and a display device structured to display the display image generated by the display control device. The display control device generates a display image in which a plurality of points with a color different from that of the guide line are arranged at intervals along the guide line.

According to another aspect of the present disclosure, a display control device is provided. The display control device includes: an acquiring unit structured to acquire an image of a periphery of a vehicle captured by an image capturing device; a generator structured to generate a display image in which a predetermined guide line overlaps the image acquired by the acquiring unit; and an output structured to output the display image generated by the generator to a display device. The generator generates a display image in which a plurality of points with a color different from that of the guide line are arranged at intervals along the guide line.

It should be noted that an arbitrary combination of the constituent elements described above and expressions of the present disclosure converted between a method, a computer program, a recording medium in which a computer program is recorded, a vehicle mounted with the present device, and the like are also effective as aspects of the present disclosure.

### BRIEF DESCRIPTION OF THE DRAWINGS

FIG. 1A is a diagram schematically illustrating a configuration of a vehicle according to one embodiment;

FIG. 1B is a diagram schematically illustrating a configuration of a vehicle according to the embodiment;

FIG. 2 is a diagram illustrating an example of a hardware configuration of a display control device of FIG. 1A;

FIG. 3 is a block diagram illustrating a functional configuration of a vehicle periphery display system according to the embodiment;

FIG. 4 is a diagram illustrating an example of a display image according to the embodiment;

FIG. 5 is a diagram illustrating an example of an arrangement of auxiliary points according to a first modification;

FIG. 6 is a diagram illustrating an example of an arrangement of auxiliary points according to a second modification; and

FIG. 7 is a diagram illustrating an example of an arrangement of auxiliary points according to a third modification.

### DETAILED DESCRIPTION

The invention will now be described by reference to the preferred embodiments. This does not intend to limit the scope of the present invention, but to exemplify the invention.

Before describing embodiments in detail, an outline will be provided. In some cases, a guide line which is a virtual line indicating a reference of a distance or the like is added on an image of the periphery of a vehicle captured by a vehicle-mounted camera. When a shadow line is added as an emphasizing means for the guide line, an area covered by the guide line and the shadow line becomes large, such that visibility of a background image including an image of a following vehicle, or the like deteriorates. In addition, in some cases, when a background is bright, the shadow line is excessively conspicuous due to a luminance difference between the dark shadow line and the bright background. Further, in some cases, a background image near the shadow line is difficult to be checked due to a large luminance difference.

A vehicle periphery display system according to embodiments is also called a camera monitoring system, and presents an image obtained by capturing an image of an area behind a host vehicle or an area beside the host vehicle to an occupant (hereinafter, referred to as a driver). In addition, the vehicle periphery display system according to the embodiments presents, to the driver, an image (hereinafter, also referred to as a display image) of which visibility for determining how far away another vehicle traveling behind the host vehicle or beside the host vehicle is from the host vehicle is improved. In the display image, an emphasizing means for a guide line is provided, and the emphasizing means is set to one aspect in which visibility of a background image is maintained. In the embodiments, a guide line added on the display image is a “distance reference line” indicating a reference of a distance from the host vehicle. However, a technology of the embodiments can also be applied to a guide line (for example, a vehicle width line for parking assistance) other than the distance reference line, that is, the emphasizing means described in the embodiments can also be added to the guide line other than the distance reference line.

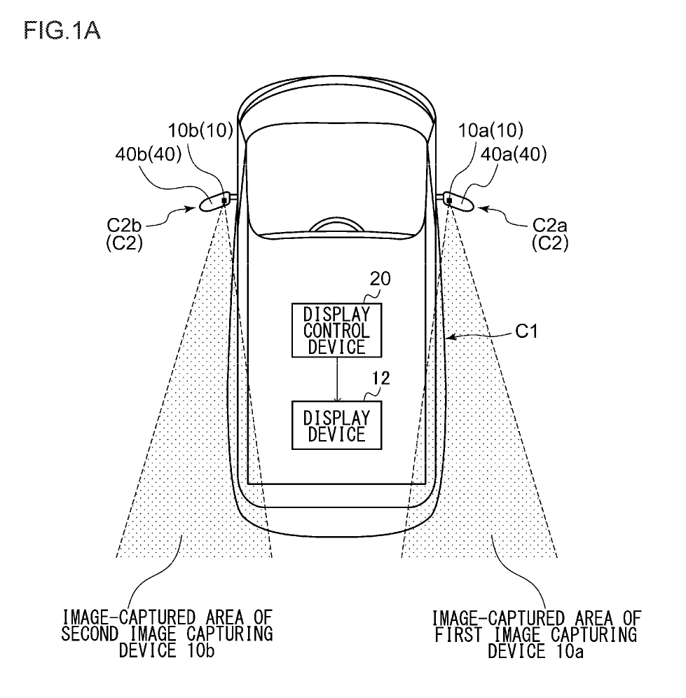

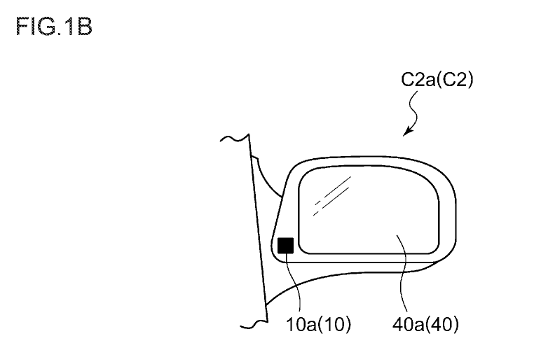

FIGS. 1A and 1B schematically illustrate a configuration of a vehicle C1 according to one embodiment. In particular, FIG. 1A illustrates a whole configuration of the vehicle C1. A vehicle periphery display system 22 to be described below is mounted in the vehicle C1. In the vehicle periphery display system 22, an image capturing device 10, a display control device 20, and a display device 12 cooperate with one another to present an image to be described later to a driver of the vehicle C1. The vehicle C1 includes a first side mirror C2a and a second side mirror C2b which are collectively called a side mirror C2, a first image capturing device 10a and a second image capturing device 10b which are collectively called the image capturing device 10, the display control device 20, and the display device 12. The first side mirror C2a is installed on the right side of the vehicle C1, and the second side mirror C2b is installed on the left side of the vehicle C1. In addition, the first image capturing device 10a and a first mirror 40a are mounted on the first side mirror C2a, and the second image capturing device 10b and a second mirror 40b are mounted on the second side mirror C2b. Here, it is assumed that the vehicle C1 is a right-hand drive vehicle.

FIG. 1B illustrates a configuration of the first side mirror C2a of the vehicle C1. The first image capturing device 10a is disposed at a base portion of the first side mirror C2a attached to a body of the vehicle C1. The second side mirror C2b also has the same structure as that of the first side mirror C2a. In FIG. 1A, the first image capturing device 10a captures an image of an area behind the right side of the vehicle C1. An area image captured by the first image capturing device 10a is indicated as an “image-captured area of the first image capturing device 10a”. Meanwhile, the second image capturing device 10b captures an image of an area behind the left side of the vehicle C1. An area image captured by the second image capturing device 10b is indicated as an “image-captured area of the second image capturing device 10b”. In addition, in the vehicle periphery display system 22, an image captured by the image capturing device 10 is displayed on the display device 12. It should be noted that side surfaces of the body of the vehicle C1 which each include a door knob are partially included in the “image-captured area of the first image capturing device 10a” and the “image-captured area of the second image capturing device 10b”, respectively.

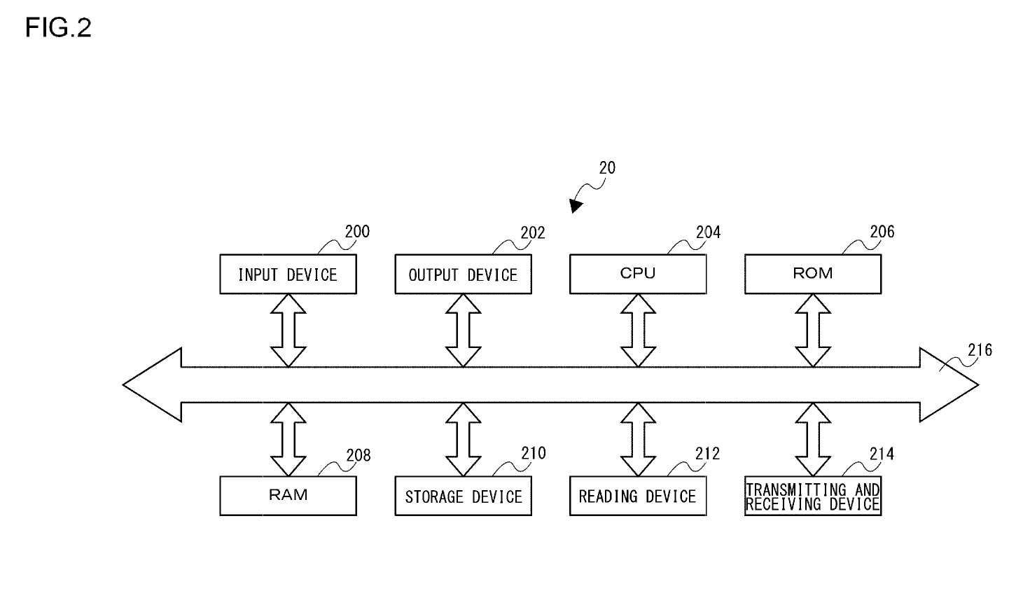

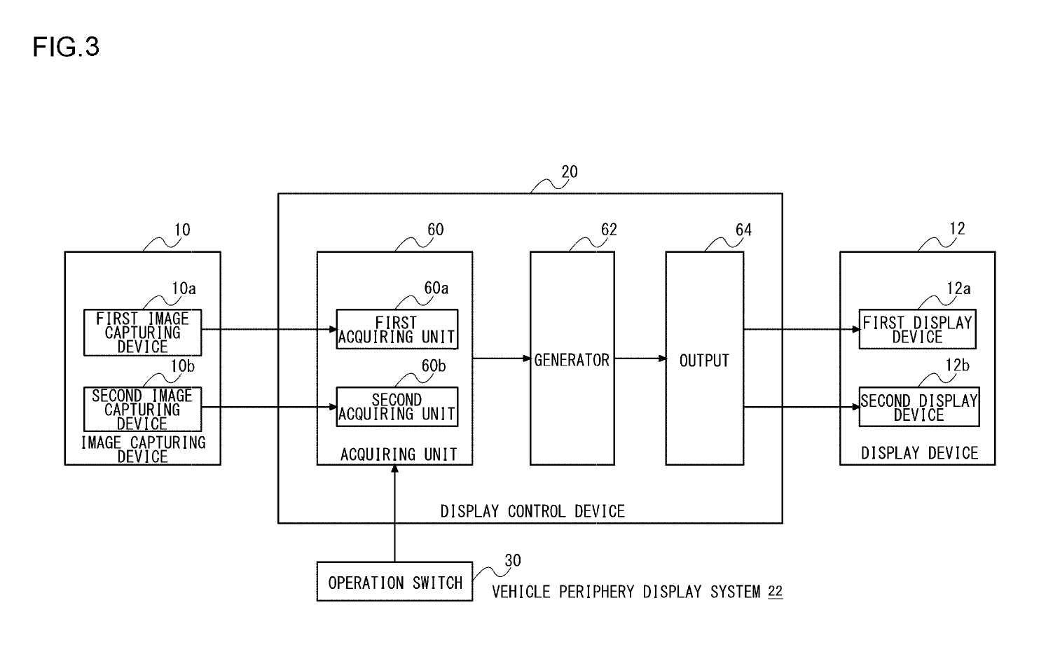

FIG. 2 illustrates an example of a hardware configuration of the display control device 20 of FIG. 1A. The display control device 20 includes an input device 200, an output device 202, a central processing unit (CPU) 204, a read only memory (ROM) 206, a random access memory (RAM) 208, a storage device 210, a reading device 212, and a transmitting and receiving device 214, which are connected to one another through a bus 216. A computer program including a plurality of modules corresponding to a plurality of functional blocks (which will be described later with reference to FIG. 3) of the display control device 20 may be installed in the ROM 206 or the storage device 210. The CPU 204 may perform functions of the respective functional blocks by reading the computer program to the RAM 208 and executing the computer program.

FIG. 3 is a block diagram illustrating a functional configuration of the vehicle periphery display system 22 according to the embodiment. As described above, the vehicle periphery display system 22 includes the image capturing device 10, the display control device 20, the display device 12, and an operation switch 30. These devices may be connected to one another through a known vehicle-mounted network such as media oriented systems transport (MOST).

Each block illustrated in the block diagram of the present disclosure can be implemented in an element such as a CPU and a memory of a computer, or mechanical equipment in terms of hardware, or can implemented by a computer program or the like in terms of software. Here, functional blocks illustrated herein are implemented by a combination thereof. Those skilled in the art will understand that these functional blocks can be implemented in various forms by a combination of hardware and software.

As illustrated in FIG. 1A, the image capturing device 10 is a video camera which captures an image of an area behind the vehicle C1 and generating an image (video) showing the area behind the vehicle C1. The image capturing device 10 outputs the captured image to the display control device 20. The display control device 20 is an information processing device which generates a display image displayed on the display device 12 based on the image captured by the image capturing device 10. The display control device 20 may be mounted as an electronic control unit (ECU). The display image is also called a driving assistant image for assisting in driving of the vehicle C1, and the display control device 20 is also called a driving assistant device.

The display device 12 displays the display image generated by the display control device 18 on a screen. The display device 12 includes a first display device 12a and a second display device 12b. An image captured by the first image capturing device 10a is displayed on the first display device 12a, and an image captured by the second image capturing device 10b is displayed on the second display device 12b.

A display of a car navigation device (not illustrated) or the like may doubles as the display device 12, or the display device 12 may be a dedicated device for the vehicle periphery display system 22. The display device 12 according to the embodiment is assumed to be provided inside (in a passenger compartment) the vehicle C1. However, the display device 12 may also be provided in a place where the mirror 40 of the side mirror C2 is disposed, instead of the mirror 40. For example, the first display device 12a may be provided at a position of a first mirror 40a of the first side mirror C2a and the second display device 12b may be provided at a position of a second mirror 40b of the second side mirror C2b.

The operation switch 30 receives an input of various operations with respect to the display control device 20. The operation switch 30 may be provided as dedicated hardware for the vehicle periphery display system 22. In addition, the operation switch 30 may be displayed on the display of the car navigation device (not illustrated) or the like as an image object. An instruction of the driver is input to the display control device 20 through the operation switch 30, and the display control device 20 generates a display image including a distance reference line according to the instruction from the driver.

The display control device 20 will each be described in detail. The display control device 20 includes a first acquiring unit 60a, a second acquiring unit 60b, a generator 62, and an output 64, which are collectively called an acquiring unit 60. The acquiring unit 60 acquires an image from the image capturing device 10. The acquiring unit 60 is configured by, for example, a non-volatile memory, and temporarily stores an image without image processing. However, a predetermined processing may be performed on the image. The first acquiring unit 60a acquires an image of an area behind the vehicle C1 captured by the first image capturing device 10a, and the second acquiring unit 60b acquires an image of an area behind the vehicle C1 captured by the second image capturing device 10b. The acquiring unit 60 outputs the acquired image to the generator 62.

The generator 62 generates a display image by processing the image captured by the first image capturing device 10a and acquired by the first acquiring unit 60a. The output 64 outputs the display image to the first display device 12a so that the display image is displayed on the first display device 12a. In addition, the generator 62 generates a display image by processing the image captured by the second image capturing device 10b and acquired by the second acquiring unit 60b. The output 64 outputs the display image to the second display device 12b so that the display image is displayed on the second display device 12b.

Hereinafter, a processing of generating a display image from an image (hereinafter, also referred to as a “captured image”) acquired by the first acquiring unit 60a will be described in detail. A processing of generating a display image from an image acquired by the second acquiring unit 60b will be described in detail as well.

The generator 62 generates a display image in which a distance reference line indicating a position separate from the vehicle C1 by a predetermined distance overlaps a captured image. In the embodiment, the generator 62 generates a display image in which a plurality of distance reference lines are arranged at a plurality of positions at different distances from the vehicle C1, respectively.

In addition, the generator 62 generates a display image in which a plurality of points (in the embodiment, one-pixel points, hereinafter, also referred to as “auxiliary points”) with a color different from that of the distance reference line are arranged at intervals along each of the plurality of distance reference lines, as an emphasizing means for the distance reference line. The generator 62 sets the color of the plurality of auxiliary points to the complementary color of the color of the distance reference line.

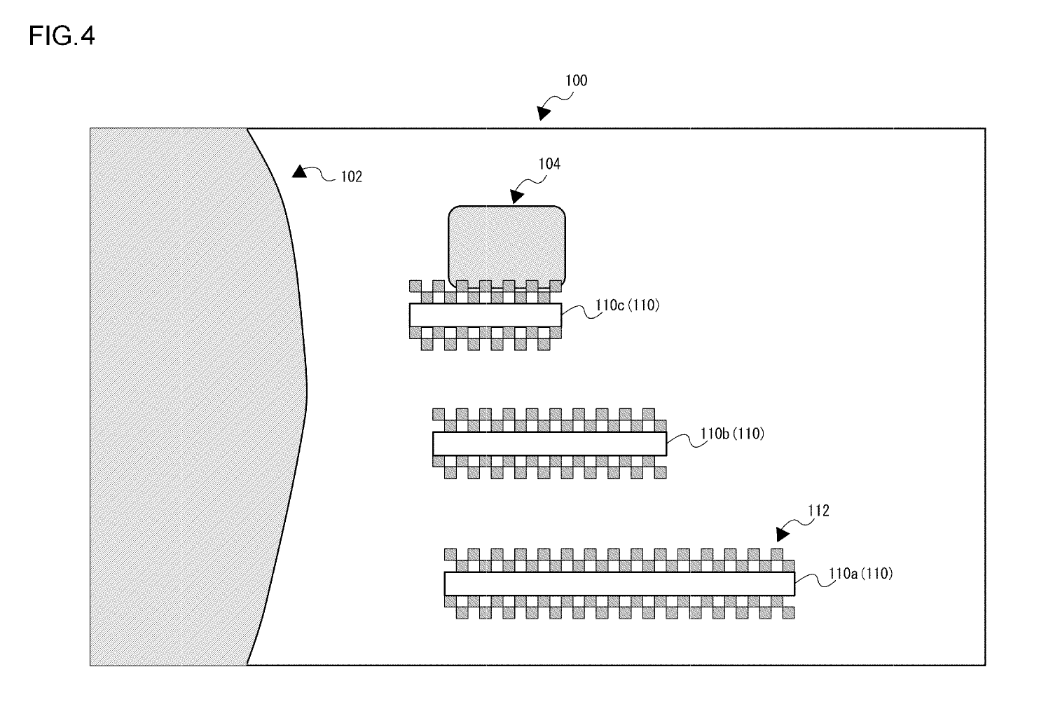

FIG. 4 illustrates an example of a display image according to the embodiment. A host vehicle image 102 which is an image of the vehicle C1 itself (the left surface of a vehicle body) and another vehicle image 104 which is an image of another vehicle traveling behind (for example, behind the vehicle C1 on an adjacent lane) the vehicle C1 are included in the display image 100. The generator 62 arranges the plurality of distance reference lines 110 in the display image 100. In detail, the generator 62 arranges a first distance reference line 110a at a position (a position behind the vehicle) separate from the vehicle C1 by 5 meters in a longitudinal direction (front and rear direction), arranges a second distance reference line 110b at a position separate from the vehicle C1 by 10 meters, and arranges a third distance reference line 110c at a position separate from the vehicle C1 by 15 meters.

In the example in FIG. 4, the generator 62 laterally aligns a plurality of auxiliary points 112 with each other at both of upper and lower sides of each of the distance reference lines 110 (the first distance reference line 110a, the second distance reference line 110b, and the third distance reference line 110c), at one pixel intervals. In detail, the generator 62 arranges two rows in which the plurality of auxiliary points 112 are laterally aligned with each other, at both of the upper and lower sides of each of the distance reference lines 110. In the example in FIG. 4, the two rows in which the auxiliary points 112 are aligned with each other are arranged so that the two rows are misaligned with each other by one pixel, that is, are arranged in a form of a checkered pattern.

In the display image 100 provided by the vehicle periphery display system 22 according to the embodiment, the plurality of auxiliary points 112 are arranged in an alternating manner, such that a width of a covered area of a background is decreased, in comparison to a case of adding solid emphasizing lines to the distance reference lines 110. For example, it is easy to confirm the other vehicle image 104 even in the row in which the auxiliary points 112 are aligned as illustrated in FIG. 4.

As described above, in the vehicle periphery display system 22 according to the embodiment, it is possible to provide the driver with the display image 100 in which the distance reference lines 110 are emphasized by the auxiliary points 112 and deterioration in visibility of the background image is suppressed. In addition, it is possible to improve visibility of the distance reference lines 110 by setting the color of the auxiliary points 112 to the complementary color of the color of the distance reference lines 110. For example, even when the background has a color similar to that of the distance reference lines 110, it is possible to make the distance reference lines 110 conspicuous by a contrast with the auxiliary points 112.

It should be noted that the generator 62 may add a row of auxiliary points 112 to any one of the upper and lower sides of each of the distance reference lines 110. In addition, the number of rows of the auxiliary points 112 added to each of the distance reference lines 110 may be one, or may be three or more. Further, the auxiliary point 112 may be a point which is larger than one pixel, for example, an N×M-pixel point (N and M are natural numbers) (also referred to as a block). In addition, an interval between the auxiliary points 112 may be two pixels or more. The effects described above are exhibited even with this configuration.

In addition, it is preferable that the color of the auxiliary points 112 is the complementary color of the color of the distance reference lines 110. However, the color of the auxiliary points 112 may be any color as long as the color of the auxiliary points 112 is at least different from the color of the distance reference lines 110. For example, when the color of the distance reference lines 110 is other than black, the color of the auxiliary points 112 may be black. Even with this configuration, it is possible to improve visibility of the distance reference lines 110 and inhibit visibility of the background image from deteriorating.

Hereinabove, the present disclosure has been described based on the embodiment. This embodiment is an example, and those skilled in the art will understand that various modifications of a combination of the respective constitutional elements or the respective processing processes of the embodiment can be made, and the modifications are also within the scope of the present disclosure.

A first modification will be described. A generator 62 of a display control device 20 may provide a plurality of rows in which a plurality of auxiliary points 112 are aligned, and arrange the auxiliary points 112 in each row so that a density of auxiliary points 112 in a row relatively closer to a distance reference line 110 is higher than that of auxiliary points 112 in a row relatively more distant from the distance reference line 110. In addition, the generator 62 may arrange the auxiliary points 112 in each row so that the closer the row among the plurality of rows is to the distance reference line 110, the higher the density of the auxiliary points 112 is. A color of the auxiliary points 112 may be the complementary color of a color of the distance reference line 110.

As described above, a row of the auxiliary points 112 may be added to any one of upper and lower sides of the distance reference line 110. In addition, the row of the auxiliary points 112 may be closely adhered to the distance reference line 110, or may be arranged while being spaced apart from the distance reference line 110 by a predetermined interval.

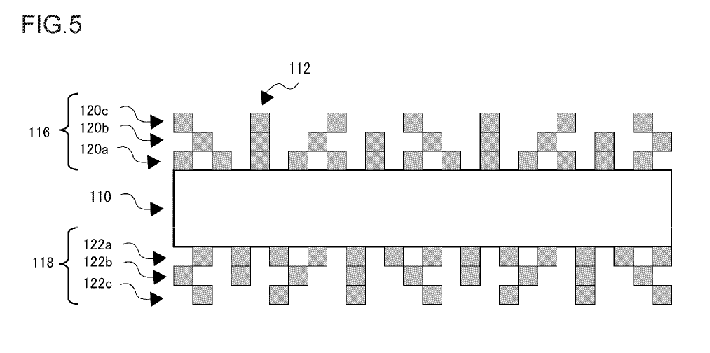

FIG. 5 illustrates an example of an arrangement of the auxiliary points according to the first modification. In the example in FIG. 5, the generator 62 arranges an upper auxiliary line 116 in which three rows of the auxiliary points 112 are aligned at an upper side of the distance reference line 110. In addition, the generator 62 arranges a lower auxiliary line 118 in which three rows of the auxiliary points 112 are aligned at a lower side of the distance reference line 110. The upper auxiliary line 116 includes, as rows of the auxiliary points 112, a first upper row 120a, a second upper row 120b, and a third upper row 120c. The lower auxiliary line 118 includes, as rows of the auxiliary points 112, a first lower row 122a, a second lower row 122b, and a third lower row 122c.

In the first upper row 120a and the first lower row 122a which are arranged at the shortest distance from the distance reference line 110 (for example, in contact with the distance reference line 110), the auxiliary points 112 are arranged at one pixel intervals. Further, in the second upper row 120b and the second lower row 122b which are arranged at the intermediate distance from the distance reference line 110, the auxiliary points 112 are arranged at two pixel intervals. Further, in the third upper row 120c and the third lower row 122c which are arranged at the longest distance from the distance reference line 110, the auxiliary points 112 are arranged at three pixel intervals.

In the aspect of the arrangement of the auxiliary points 112 according to the first modification, the closer the auxiliary points 112 are to the distance reference line 110, the higher the density of the auxiliary points 112 is, such that it is possible to improve visibility of the distance reference line 110 by a contrast with the auxiliary points 112. In addition, it is possible to further improve visibility of the background image at a position distant from the distance reference line 110.

A second modification will be described. A generator 62 of a display control device 20 may arrange a plurality of auxiliary points 112 along an edge of an upper side of a distance reference line 110 and set a color of the plurality of auxiliary points 112 to a color with higher brightness than that of a color of the distance reference line 110. In addition, the generator 62 may arrange a plurality of auxiliary points 112 along an edge of a lower side of the distance reference line 110 and set a color of the plurality of auxiliary points 112 to a color with lower brightness than that of the color of the distance reference line 110.

A hue and a saturation of the auxiliary points 112 are not limited. For example, the generator 62 may set the color of the auxiliary points 112 at the upper side of the distance reference line 110 and the color of the auxiliary points 112 at the lower side of the distance reference line 110 to the complementary color of the color of the distance reference line 110. In this case, the auxiliary points 112 at the upper side of the distance reference line 110 and the auxiliary points 112 at the lower side of the distance reference line 110 have the same color. However, brightness of the auxiliary points 112 at the upper side of the distance reference line 110 and brightness of the auxiliary points 112 at the lower side of the distance reference line 110 may be different from each other (the brightness of the auxiliary points 112 at the lower side of the distance reference line 110 is lower).

Further, in the second modification, the generator 62 provides rows of the auxiliary points 112 at both of the upper and lower sides of the distance reference line 110, and the rows of the auxiliary points 112 may be added to any one of the upper and lower sides of the distance reference line 110. In addition, the row of the auxiliary points 112 may be closely adhered to the distance reference line 110, or may by arranged while being spaced apart from the distance reference line 110 by a predetermined interval.

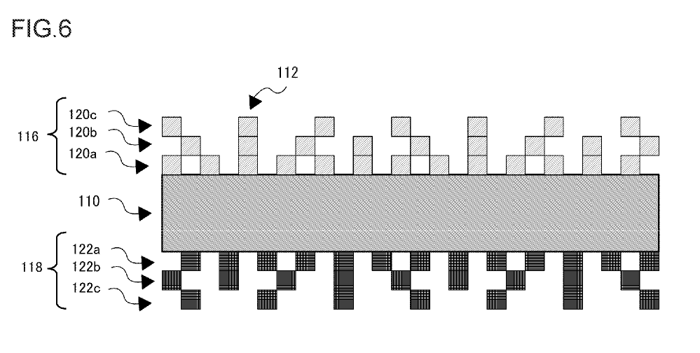

FIG. 6 illustrates an example of an arrangement of the auxiliary points according to the second modification. Arrangement positions of the auxiliary points 112 in FIG. 6 are the same as in the first modification (FIG. 5), that is, the auxiliary points 112 are arranged so that the closer the auxiliary points 112 are to the distance reference line 110, the higher the density of the auxiliary points 112 is. In addition, the generator 62 sets a color of the auxiliary points 112 constituting an upper auxiliary line 116 to a color with brightness higher than that of the color of the distance reference line 110. In addition, the generator 62 sets a color of the auxiliary points 112 constituting a lower auxiliary line 118 to a color with brightness lower than that of the color of the distance reference line 110. That is, when elements in FIG. 6 are aligned in a descending order of brightness, the upper auxiliary line 116, the distance reference line 110, and the lower auxiliary line 118 are aligned sequentially.

In the aspect of color setting of the auxiliary points 112 according to the second modification, the distance reference line 110, the upper auxiliary line 116, and the lower auxiliary line 118 have a difference in brightness, such that it is possible to further improve visibility of the distance reference line 110.

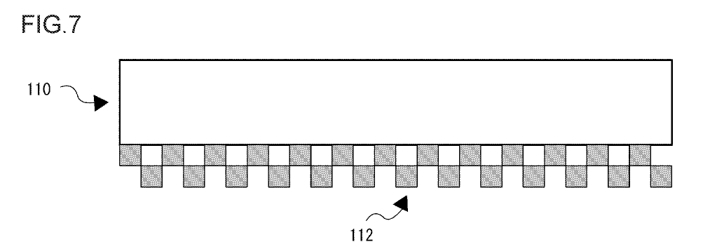

A third modification will be described. A generator 62 of a display control device 20 may arrange auxiliary points 112 at an edge (that is, an edge of a lower side) of a side of each of distance reference lines 110 which is closer to a vehicle C1 and need not arrange auxiliary points 112 at an edge (that is, an edge of an upper side) of a side of each of the distance reference lines 110 which is more distant from the vehicle C1. FIG. 7 illustrates an example of an arrangement of the auxiliary points according to the third modification. In FIG. 7, the auxiliary points 112 are arranged only at the lower side of the distance reference line 110. As one aspect of the plurality of auxiliary points 112 in the third modification, one aspect of the lower auxiliary line 118 described in the first modification or the second modification may be adopted.

The “color” in the embodiment and the modifications described above may include a color expressed by a difference in the depth of color, or may include a color expressed by a difference in luminance.

An arbitrary combination of the embodiment and modifications described above is also useful as one embodiment of the present disclosure. A new embodiment generated by the combination has the effects of both of the embodiment and the modifications which are combined. In addition, those skilled in the art will also understand that the functions which should be performed by respective constituent elements described in the claims are implemented by a single constituent element or cooperation of the constituent elements described in the embodiment and the modifications.

The technology described in the embodiment and the modifications may be specified by the following articles.

### Article 1

A vehicle periphery display system, including: an image capturing device structured to capture an image of a periphery of a vehicle; a display control device structured to generate a display image in which a predetermined guide line overlaps the image captured by the image capturing device; and a display device structured to display the display image generated by the display control device, wherein the display control device generates the display image in which a plurality of points with a color different from that of the guide line are arranged at intervals along the guide line.

According to the vehicle periphery display system, it is possible to improve visibility of the guide line and inhibit visibility of a background image from deteriorating.

### Article 2

The vehicle periphery display system according to article 1, wherein the display control device sets the color of the plurality of points to the complementary color of a color of the guide line.

According to the vehicle periphery display system, it is possible to further improve visibility of the guide line.

### Article 3

The vehicle periphery display system according to article 1 or 2, wherein the display control device arranges the plurality of points along an edge of an upper side of the guide line and sets a color of the points to a color with brightness higher than that of the color of the guide line.

According to the vehicle periphery display system, it is possible to further improve visibility of the guide line.

### Article 4

The vehicle periphery display system according to any one of articles 1 to 3, wherein the display control device arranges the plurality of points along an edge of a lower side of the guide line and sets a color of the points to a color with brightness lower than that of the color of the guide line.

According to the vehicle periphery display system, it is possible to further improve visibility of the guide line.

### Article 5

The vehicle periphery display system according to any one of articles 1 to 4, wherein the display control device provides a plurality of rows in which the plurality of points are arranged, and arranges the points in each row so that a density of the points in a row relatively closer to the guide line is higher than that of the points in a row relatively more distant from the guide line.

According to the vehicle periphery display system, it is possible to further improve visibility of the guide line.

### Article 6

A display control device, including: an acquiring unit structured to acquire an image of a periphery of a vehicle captured by an image capturing device; a generator structured to generate a display image in which a predetermined guide line overlaps the image acquired by the acquiring unit; and an output structured to output the display image generated by the generator to a display device, wherein the generator generates the display image in which a plurality of points with a color different from that of the guide line are arranged at intervals along the guide line.

According to the display control device, it is possible to improve visibility of the guide line and inhibit visibility of a background image from deteriorating.

### Article 7

A computer program causing a computer to execute the following processes of: acquiring an image of a periphery of a vehicle captured by an image capturing device; generating a display image in which a predetermined guide line overlaps the acquired image and a plurality of points with a color different from that of the guide line are arranged at intervals along the guide line, and outputting the generated display image to a display device.

According to the computer program, it is possible to improve visibility of the guide line and inhibit visibility of a background image from deteriorating.

What is claimed is:

1. A vehicle periphery display system, comprising:
an image capturing device structured to capture an image of a periphery of a vehicle;
a display control device structured to generate a display image in which a predetermined guide line overlaps the image captured by the image capturing device; and
a display device structured to display the display image generated by the display control device,
wherein the display control device generates a display image in which a plurality of points with a color different from that of the guide line are arranged at intervals along the guide line.

2. The vehicle periphery display system according to claim 1, wherein the display control device sets the color of the plurality of points to the complementary color of a color of the guide line.

3. The vehicle periphery display system according to claim 1, wherein the display control device arranges the plurality of points along an edge of an upper side of the guide line and sets a color of the points to a color with brightness higher than that of the color of the guide line.

4. The vehicle periphery display system according to claim 1, wherein the display control device arranges the plurality of points along an edge of a lower side of the guide line and sets a color of the points to a color with brightness lower than that of the color of the guide line.

5. The vehicle periphery display system according to claim 1, wherein the display control device provides a plurality of rows in which the plurality of points are arranged, and arranges the points in each row so that a density of the points in a row relatively closer to the guide line is higher than that of the points in a row relatively more distant from the guide line.

6. A display control device, comprising:
an acquiring unit structured to acquire an image of a periphery of a vehicle captured by an image capturing device;
a generator structured to generate a display image in which a predetermined guide line overlaps the image acquired by the acquiring unit; and
an output structured to output the display image generated by the generator to a display device,
wherein the generator generates a display image in which a plurality of points with a color different from that of the guide line are arranged at intervals along the guide line.

7. A recording medium storing a computer program, the computer program causing a computer to execute the following processes of:
acquiring an image of a periphery of a vehicle captured by an image capturing device;
generating a display image in which a predetermined guide line overlaps the acquired image and a plurality of points with a color different from that of the guide line are arranged at intervals along the guide line; and
outputting the generated display image to a display device.
